(19) United States
(12) Patent Application Publication
(10) Pub. No.: US 2025/0128441 A1
(43) Pub. Date: Apr. 24, 2025

(54) RAZOR CARTRIDGE AND RAZOR ASSEMBLY INCLUDING THE SAME

(71) Applicant: DORCO CO., LTD., Seoul (KR)

(72) Inventor: Da Woon HAN, Seoul (KR)

(21) Appl. No.: 18/917,754

(22) Filed: Oct. 16, 2024

(30) Foreign Application Priority Data
Oct. 18, 2023 (KR) 10-2023-0139772

(51) Int. Cl. B26B 21/40; B26B 21/52

(52) U.S. Cl. CPC B26B 21/4018; B26B 21/4037; B26B 21/521; B26B 21/526

(57) ABSTRACT

A razor cartridge is proposed. The razor cartridge may include at least one razor blade having a cutting edge formed thereon, and a blade housing configured to accommodate the razor blade in a longitudinal direction. The razor cartridge may also include a housing cover including a razor blade window configured to expose at least a portion of the cutting edge and a window frame surrounding at least a portion of the razor blade window and connected to the blade housing. The window frame may include a plastic guard provided in front of the razor blade, and the plastic guard may include a transparent or translucent material.

### CROSS REFERENCE TO RELATED APPLICATION

This application claims priority from Republic of Korea Patent Application No. 10-2023-0139772, filed on Oct. 18, 2023, which is hereby incorporated by reference in its entirety.

### BACKGROUND

### Technical Field

The present disclosure relates to a razor cartridge and a razor assembly including the same, and more specifically, to a razor cartridge accommodating at least one razor blade, and a razor assembly including the razor cartridge and a razor handle.

### Description of Related Technology

Generally, a razor is a product for cutting hair such as facial hair or beard, and includes a razor handle for gripping and a razor cartridge having a razor blade that comes into contact with a skin to perform shaving.

### SUMMARY

One aspect is a razor cartridge in which at least a part of a guard region of a razor cartridge is formed of a light transmitting material, and a razor assembly including the same.

The aspects of the present disclosure are not limited to the aspects described above, and other aspects not mentioned can be clearly understood by those skilled in the art from the description below.

Another aspect is a razor cartridge including: at least one razor blade having a cutting edge formed thereon; a blade housing configured to accommodate the razor blade in a longitudinal direction; and a housing cover including a razor blade window in which at least a portion of the cutting edge is exposed and a window frame formed to surround at least a portion of the razor blade window and connected to the blade housing, in which the window frame includes a plastic guard provided in front of the razor blade, and the plastic guard is formed of a transparent or translucent material.

Another aspect is a razor assembly including: a razor cartridge; and a razor handle, in which the razor cartridge includes at least one razor blade having a cutting edge formed thereon, a blade housing which accommodates the razor blade in a longitudinal direction and to which the razor handle is coupled, and a housing cover including a razor blade window in which at least a portion of the cutting edge is exposed and a window frame formed to surround at least a portion of the razor blade window and connected to the blade housing, the window frame includes a plastic guard provided in front of the razor blade, and the plastic guard is formed of a light-transmitting material.

Other specific details of the present disclosure are included in the detailed description and drawings.

The embodiments of the present disclosure have at least the following effects.

The razor cartridge and the razor assembly according to an embodiment of the present disclosure include the plastic guard formed of a light-transmitting material in the razor cartridge, so that a user can visually confirm the exact position of the razor blade during shaving.

A razor cartridge and a razor assembly according to an embodiment of the present disclosure include the plastic guard formed of a light-transmitting material in the razor cartridge, so that light emitted from a light source passes through the plastic guard and is emitted onto the skin, so that a user can accurately recognize the area being shaved, and shaving is possible even in a dark environment.

The effects of the present disclosure are not limited to the contents exemplified above, and more diverse effects are included in the present specification.

### BRIEF DESCRIPTION OF THE DRAWINGS

FIG. 1 is a perspective view illustrating a razor cartridge according to one embodiment of the present disclosure.

FIG. 2 is a bottom view of the razor cartridge according to one embodiment of the present disclosure.

FIG. 3 is an exploded perspective view of the razor cartridge according to one embodiment of the present disclosure.

FIG. 4 is a perspective view illustrating a cross section of the razor cartridge according to one embodiment of the present disclosure.

FIG. 5 is a sectional view of the razor cartridge according to one embodiment of the present disclosure.

FIG. 6 is an exploded perspective view of a razor cartridge according to another embodiment of the present disclosure.

FIG. 7 is a perspective view illustrating a razor cartridge according to still another embodiment of the present disclosure.

FIG. 8 is an exploded perspective view of the razor cartridge according to still another embodiment of the present disclosure.

FIG. 9 is a perspective view illustrating a cross section of the razor cartridge according to still another embodiment of the present disclosure.

FIG. 10 is a side view schematically illustrating a razor assembly according to one embodiment of the present disclosure.

### DETAILED DESCRIPTION

Generally, when shaving facial beard, a user performs shaving while checking a shaving area through a mirror.

Since an upper surface of the razor cartridge, where the cutting edge of the razor blade is exposed, is in close contact with the skin, the user anticipates the shaving area by looking at the lower surface of the razor cartridge through a mirror and proceeds with shaving.

In general, since the razor cartridge includes, in addition to a plurality of razor blades, a configuration for supporting the razor blades, a rubber guard for pulling the skin to be shaved, a lubricating band for applying a lubricating substance to the shaved skin, or the like, it is difficult to accurately determine the position of the razor blades, the condition of the skin to be shaved, or the like during the shaving process.

The advantages and features of the present disclosure, and the method for achieving them will be clarified by referring to the embodiments described in detail below with the attached drawings. However, the present disclosure is not limited to the embodiments disclosed below, but may be implemented in various different forms, and these embodiments are provided only to ensure that the disclosure of the present disclosure is complete and to fully inform a person having ordinary knowledge in the technical field to which the present disclosure belongs of the scope of the disclosure, and the present disclosure is defined only by the scope of the claims.

In addition, the embodiments described in the present specification will be described with reference to cross sectional views and/or schematic views, which are ideal examples of the present disclosure. Accordingly, the form of the examples may be modified due to manufacturing technology and/or tolerances. In addition, each component in each drawing illustrated in the present disclosure may be illustrated somewhat enlarged or reduced in consideration of the convenience of explanation. The same reference numerals refer to the same components throughout the specification.

In addition, when describing the components of the embodiments of the present disclosure, symbols such as first, second, i), ii), a), b) may be used. These symbols are only for distinguishing the components from other components, and the nature or order or sequence of the components is not limited by the symbols. When a part of the specification is said to “include” or “provide” a component, this does not mean that other components are excluded, but rather that other components may be further included, unless explicitly stated otherwise.

Hereinafter, the present disclosure will be described with reference to drawings for explaining a razor cartridge according to embodiments of the present disclosure and a razor assembly including the same.

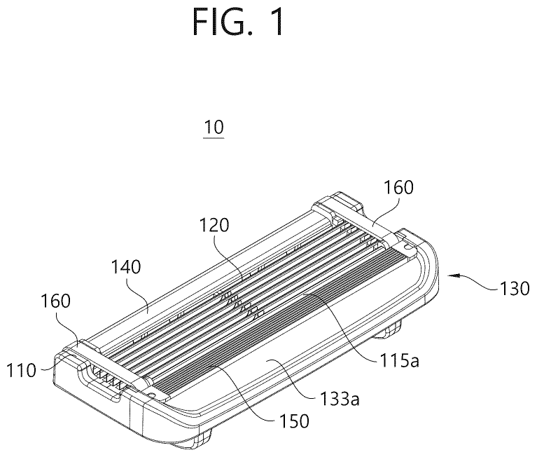

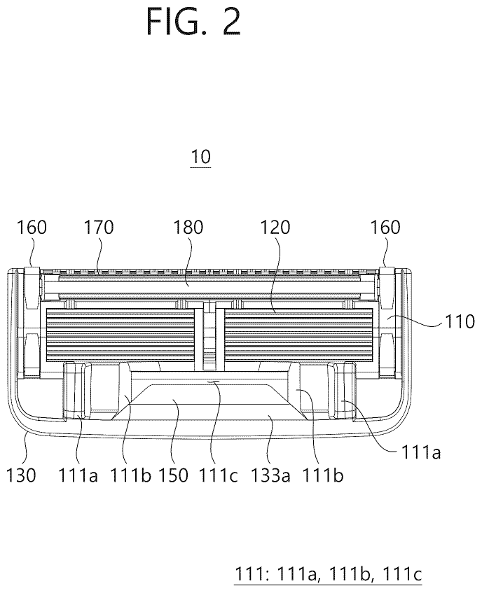

FIG. 1 is a perspective view illustrating a razor cartridge according to one embodiment of the present disclosure, and FIG. 2 is a bottom view of the razor cartridge according to the embodiment of the present disclosure.

Referring to FIGS. 1 and 2, a razor cartridge 10 according to the embodiment of the present disclosure includes a blade housing 110, a plurality of razor blades 120, and a housing cover 130.

The blade housing 110 accommodates each razor blade 120 in a longitudinal direction. Each razor blade 120 may be arranged in a transverse row. With reference to FIG. 2, the longitudinal direction means a horizontal direction, and the transverse direction means a vertical direction. Although FIGS. 1 and 2 illustrate an example in which six razor blades 120 are included in the razor cartridge 10, the number of razor blades 120 may vary depending on the embodiment.

An upper surface of the blade housing 110 described below is a surface that comes into contact with or faces a user's skin during a shaving process. A lower surface of the blade housing 110 is a surface located on a side opposite to the upper surface, and the lower surface of the blade housing 110 is illustrated in FIG. 2.

The front of the blade housing 110 may be the direction (shaving direction) in which the blade housing 110 moves relative to the user's skin during the shaving process. For example, the front of the blade housing 110 means downward with reference to FIG. 2.

The rear of the blade housing 110 means upward with reference to FIG. 2 in a direction opposite to the aforementioned front.

Referring to FIG. 2, the razor cartridge 10 may include a connector 111 provided on the lower surface of the blade housing 110.

The connector 111 is configured to be detachably coupled with a razor handle. The connector 111 may be coupled to the lower surface of the blade housing 110 or formed integrally with the blade housing 110.

The connector 111 may include a pair of connecting posts 111a, a pair of guide surfaces 111b, and a connecting groove 111c.

The pair of connecting posts 111a may be formed to protrude from the blade housing 110 in a state of being longitudinally spaced apart from each other. A space between the pair of connecting posts 111a forms a space into which a connecting member of a razor handle, which will be described later, enters. The connecting member is a member that is detachably coupled with the connector 111.

The pair of guide surfaces 111b are provided between the connecting groove 111c and the pair of connecting posts 111a to guide the connecting member of the razor handle to enter the connecting groove 111c. To this end, the pair of guide surfaces 111b may include a downwardly inclined surface from the pair of connecting posts 111a toward the connecting groove 111c.

The connecting groove 111c accommodates the connecting member of the razor handle and is detachably coupled with the connecting member. For example, the connecting groove 111c may be configured to be hook-coupled to the connecting member a detachable manner.

As illustrated in FIG. 2, the connector 111 may be arranged so as not to overlap with the plurality of razor blades 120. This arrangement relationship allows shaving residue (for example, shaving cream, cut hair, or the like) to be effectively discharged together with the washing water into a space between the plurality of razor blades 120.

The razor blade 120 is formed with a sharp cutting edge (not illustrated) at an end portion thereof. Referring to FIG. 1, the razor blade 120 is mounted or supported on the blade housing 110 so that the cutting edge is exposed to the upper surface of the blade housing 110. In addition, the razor blade 120 is mounted or supported on the blade housing 110 so that the cutting edge faces the front of the blade housing 110.

The housing cover 130 is connected to the blade housing 110 and expands the guard region formed at the front of the razor blade 120. The guard region is located at the front of the razor blade 120 and may perform the function of supporting or pulling the skin by coming into contact with the skin before the razor blade 120 during the shaving process. Referring to FIG. 1, the guard region may include a guard bar 115a, an elastic guard 150, and a plastic guard 133a positioned in front of the razor blade 120.

In particular, the plastic guard 133a of the housing cover 130 may be formed of a light-transmitting material. That is, the plastic guard 133a may be formed of a transparent or translucent material.

Since the plastic guard 133a of the razor cartridge 10 according to the present embodiment is formed of a light-transmitting material, the user can visually confirm the exact position of the razor blade 120 during shaving.

In particular, since the upper surface of the razor cartridge 10 remains in contact with the skin during shaving, the user can perform shaving while checking the lower surface of the razor cartridge 10 through a mirror. According to the present embodiment, since the plastic guard 133a of the razor cartridge 10 is formed of a light-transmitting material, the user can visually check the skin supported by the plastic guard 133a during shaving, and accurately recognize the current position of the razor blade 120 and the position of the skin to be shaved by the razor blade 120 later. In particular, when shaving a narrow area such as under the nose or a region requiring precise shaving, the shaving area and/or the area to be shaved can be visually checked through the plastic guard 133a, thereby enabling safer and more accurate shaving.

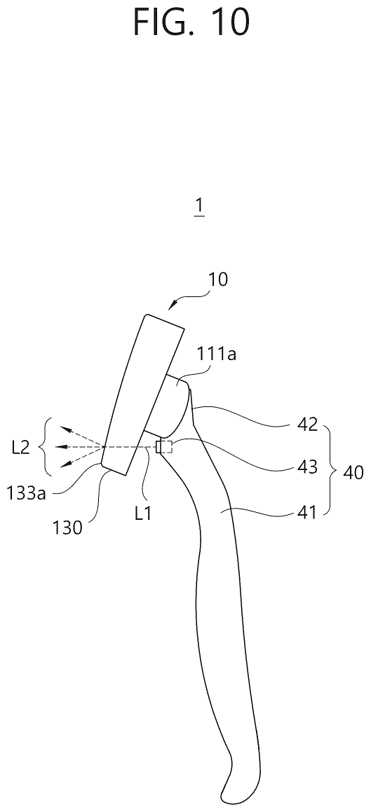

In addition, since the plastic guard 133a is formed of a light-transmitting material, light emitted from the light can pass through the plastic guard 133a and be emitted to the skin. Therefore, the user can more easily visually check the skin supported by the plastic guard 133a. When a light source that emits light is provided in the razor handle (see FIG. 10), the light emitted from the razor handle passes through the plastic guard 133a and is emitted onto the skin, so that even in a dark environment, the user can visually check the skin supported by the plastic guard 133a, and thus shaving is possible even in a dark environment.

Hereinafter, with reference to an exploded perspective view, the components of the razor cartridge 10 according to one embodiment of the present disclosure will be described in more detail.

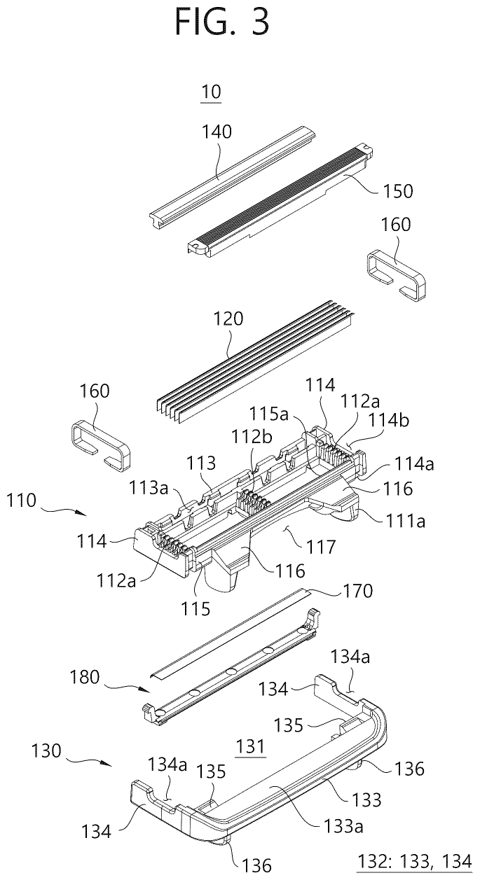

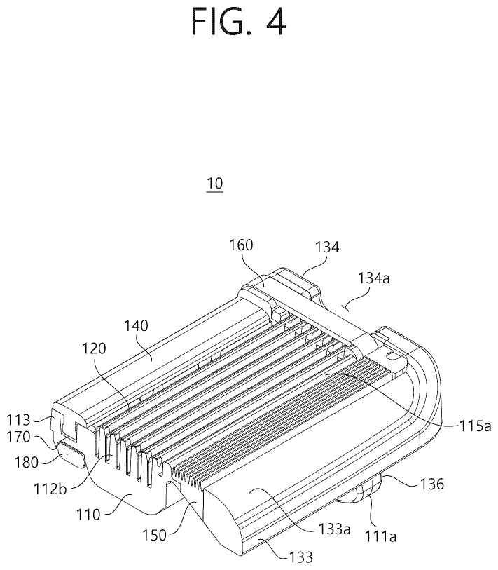

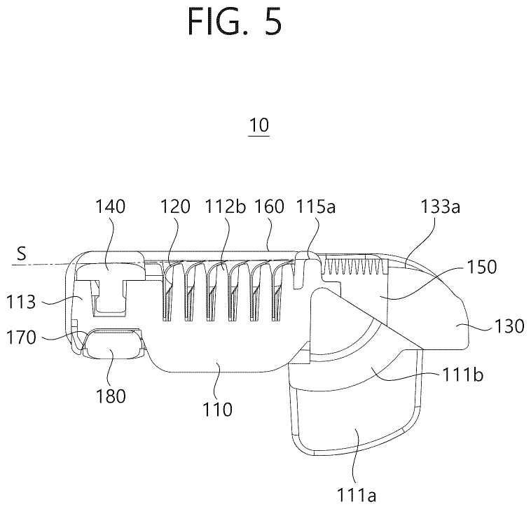

FIG. 3 is an exploded perspective view of the razor cartridge according to one embodiment of the present disclosure, FIG. 4 is a perspective view illustrating a cross section of the razor cartridge according to one embodiment of the present disclosure, and FIG. 5 is a sectional view of the razor cartridge according to one embodiment of the present disclosure.

Referring to FIGS. 3 and 4, as described above, the razor cartridge 10 according to one embodiment of the present disclosure includes the blade housing 110, the plurality of razor blades 120 and the housing cover 130, and may further include at least some of a lubricating band 140, an elastic guard 150, a clip 160, a trimming blade 170, and a trimmer support 180.

Referring to FIG. 3, the blade housing 110 includes a rear portion 113 positioned at the rear of the razor blade 120, side portions 114 positioned at each of the two sides of the razor blade 120, and a front portion 115 positioned at the front of the razor blade 120.

First razor blade supports 112a for supporting and accommodating both sides of the razor blade 120 may be provided on the side portions 114 on both sides. A second razor blade support 112b may be provided between the first razor blade support 112a on both sides to support and accommodate the central portion of the razor blade 120. The second razor blade support 112b may be configured to connect the front portion 115 and the rear portion 113. The first razor blade support 112a and/or the second razor blade support 112b may be configured to elastically support the razor blade 120.

A space between the first razor blade support 112a and the second razor blade support 112b may be formed to penetrate in the up and down direction. The space between the first razor blade support 112a and the second razor blade support 112b may be used as a rinsing space in which shaving residue is discharged.

A clip groove 114a for accommodating the clip 160 may be formed in the side portion 114. The clip 160 is positioned on an upper side of both sides of the razor blade 120 to prevent the razor blade 120 from being separated upward. The clip groove 114a may be formed to be positioned on the same line in the transverse direction as the first razor blade support 112a.

Referring to FIGS. 3 and 4, a first discharge hole 114b which is recessed to be opened in the outward direction of the blade housing 110 may be formed in the side portion 114. The first discharge hole 114b allows shaving residue existing between the razor blades 120 to be discharged laterally during the shaving process and/or the washing process.

The rear portion 113 may be formed to connect the side portions 114 on both sides, and a lubricating band accommodating groove 113a for accommodating a lubricating band 140 may be formed on an upper portion of the rear portion 113. The lubricating band 140 may be installed so that an upper surface thereof is exposed to the upper surface of the blade housing 110. The lubricating band 140 includes a lubricating material and allows the lubricating material to be applied to the skin surface that the razor blade 120 passes through during the shaving process. The lubricating material may include ingredients for protecting the skin after shaving.

Referring to FIG. 4, a trimmer accommodating groove (not illustrated) for accommodating the trimming blade 170 and the trimmer support 180 may be formed on a lower surface of the rear portion 113.

Referring to FIGS. 4 and 5, the trimmer support 180 is coupled to the rear portion 113 so that the trimming blade 170 is positioned between the trimmer support 180 and the lower surface of the rear portion 113. A lubricating material may be applied to a lower surface of the trimmer support 180.

The trimming blade 170 is a razor blade having a cutting edge formed therein, and is accommodated in the trimmer accommodating groove so that the cutting edge is exposed to the lower surface of the blade housing 110.

The front portion 115 may be formed to connect the side portions 114 on both sides, and a guard bar 115a arranged in front of the razor blade 120 may be formed on an upper surface of the front portion 115.

The guard bar 115a is positioned between the frontmost razor blade and the elastic guard 150. The guard bar 115a can support the skin during the shaving process and prevent the skin from being cut by the frontmost razor blade.

Referring to FIG. 5, a plane connecting an upper surface of the guard bar 115a and an upper surface of the lubricating band 140 may be defined as a shaving plane S. Alternatively, the shaving plane S may be defined as a plane connecting the upper surface of the guard bar 115a and a part of the upper surface of the rear portion 113. The cutting edge of the razor blade 120 may be positioned adjacent to the shaving plane S, and at least some of the razor blades 120 may be positioned below the shaving plane S or above the shaving plane S. For example, among the razor blades 120, the razor blades positioned at the front may be positioned so that cutting edges have a negative exposure value positioned lower than the shaving plane S to prevent skin cuts, and among the razor blades 120, the razor blades positioned at the rear may be positioned so that cutting edges have a positive exposure value positioned higher than the shaving plane S to ensure a cleaner shave, and among the razor blades 120, the razor blades positioned at the center may be positioned so that cutting edges have an exposure value of 0 positioned on the shaving plane S.

Referring to FIG. 3, the blade housing 110 may further include a first guard support 116 extending forward from the front portion 115.

The first guard support 116 supports the elastic guard 150. The elastic guard 150 is in close contact with the user's skin during the shaving process and pulls the skin to improve the shaving effect by the razor blade 120. In order for the elastic guard 150 to pull the user's skin more effectively, a pattern formed in an embossed or engraved shape may be formed on an upper surface of the elastic guard 150, and the upper surface of the elastic guard 150 may be formed of a material such as rubber or silicone.

Referring to FIG. 3, a through slit 117 penetrating in the up and down direction may be formed on the first guard support 116. Referring to FIGS. 4 and 5, the elastic guard 150 may be inserted into the through slit 117 and exposed through the lower surface of the blade housing 110.

Referring to FIG. 2, the through slit 117 may be formed to be located within the connecting groove 111c. The elastic guard 150 exposed through the through slit 117 to the lower surface of the blade housing 110 may function as an indicator to visually confirm the entry position of the razor handle within the connecting groove 111c. In order for the coupling direction of the razor handle to be visually recognized, the through slit 117 may be formed such that a longitudinal width thereof gradually decreases along the entry direction of the razor handle, and a part of the elastic guard 150 exposed through the through slit 117 to the lower surface of the blade housing 110 may also be configured such that a longitudinal width thereof gradually decreases along the entry direction of the razor handle. In addition, in order for the user to easily visually recognize the elastic guard 150 exposed through the through slit 117, the elastic guard 150 and the blade housing 110 may be formed in different colors.

In addition, referring to FIG. 2, the through slit 117 overlaps with a part of the plastic guard 133a, so that light passing through the plastic guard 133a from the rear of the razor cartridge 10 may be emitted to the front of the razor cartridge 10 through the through slit 117.

Referring to FIG. 2 and FIG. 3, a lower surface of the front portion 115 may be provided with the pair of connecting posts 111a, the pair of guide surfaces 111b, and the connecting groove 111c as described above.

The housing cover 130 includes a razor blade window 131 through which at least a portion of the cutting edge of the razor blade 120 is exposed, and a window frame 132 formed to surround at least a portion of the razor blade window 131.

Referring to FIG. 3, the window frame 132 may include a front frame 133 positioned in front of the razor blade 120 and a side frame 134 positioned on each of both sides of the razor blade 120.

The side frame 134 may extend rearward from both sides of the front frame 133 and may be coupled to the outer side of the side portion 114 of the blade housing 110. The side frame 134 is a part that the user holds with his or her fingers when holding the razor cartridge 10. Since the side frame 134 is coupled to the outside of the side portion 114, it sufficiently separates the finger from the razor blade 120 and prevents the finger from being cut by the razor blade 120.

In addition, at least a part of the side frame 134 may be formed of a light-transmitting material, thereby expanding a light-transmitting region of the razor cartridge 10. The light-transmitting portion of the side frame 134 may extend from the plastic guard 133a.

Referring to FIGS. 3 and 4, a second discharge hole 134a communicating with the first discharge hole 114b may be formed in the side frame 134. In a state where the housing cover 130 is coupled to the blade housing 110, the second discharge hole 134a may be arranged longitudinally parallel to the first discharge hole 114b. The first discharge hole 114b and the second discharge hole 134a enable the lateral discharge of shaving residue and the lateral inflow of washing water, thereby improving discharge and washing effects of shaving residue existing between the razor blades 120.

The front frame 133 includes the plastic guard 133a positioned in front of the razor blade 120. As described above, the plastic guard 133a can be formed of a transparent or translucent material.

The razor cartridge 10 according to the present embodiment has a newly formed plastic guard region compared to the conventional razor cartridge for light transmission through the plastic guard 133a. In order to prevent the skin from excessively slipping in the plastic guard region during the shaving process, the plastic guard 133a may have at least a portion of the upper surface formed as an uneven region of an irregular pattern. The uneven region may be formed to have a longitudinal surface roughness (Ra) of between 100 and 300 micrometers.

The plastic guard 133a including the uneven region passes over the skin before the razor blade 120 during the shaving process, removes dead skin cells and/or excessively applied shaving foam attached to the skin or beard, and pulls the skin to improve the shaving effect by the razor blade 120. The uneven region may be formed adjacent to the elastic guard 150 within the plastic guard 133a.

In addition, the uneven region may scatter light passing through the plastic guard 133a so that the illuminance of light emitted to the skin becomes uniform overall.

Referring to FIG. 5, an upper surface of the plastic guard 133a may be located lower than the shaving plane S, and may be located lower than the cutting edge of the razor blade 120, the guard bar 115a, and/or the upper surface of the elastic guard 150.

A ratio of the area of the plastic guard 133a to the cartridge front region located in front of the razor blade 120 may be 0.2 to 0.9. The cartridge front region may be a concept including the guard bar 115a, the elastic guard 150, and the front frame 133.

A ratio of the area of the uneven region to the cartridge front region may be 0.2 to 0.3.

Referring to FIG. 3, the front frame 133 may further include a second guard support member 135 extending rearwardly from the plastic guard 133a. The second guard support member 135 may support the elastic guard 150 together with the first guard support 116.

Referring to FIG. 3 and FIG. 4, the front frame 133 may further include a pair of reinforcing posts 136 extending downwardly. The reinforcing posts 136 may each be coupled to the outer side of the connecting post 111a.

The reinforcing posts 136 and the side frame 134 may increase the contact area between the blade housing 110 and the housing cover 130, thereby strengthening the coupling force between the blade housing 110 and the housing cover 130.

The housing cover 130 may be formed of a light transmitting material only for the plastic guard 133a, or may be formed of a light transmitting material only for the front frame 133. Alternatively, the housing cover 130 may be formed entirely of a light transmitting material.

Referring to FIG. 2, the connector 111 of the blade housing 110 is formed of an opaque material, and when the plastic guard 133a, the front frame 133, or the housing cover 130 is formed of a light-transmitting material, the connector 111 may be more clearly visually distinguished from the lower surface of the razor cartridge 10.

The blade housing 110 may be formed of an opaque material to be distinguished from the housing cover 130, but depending on the embodiment, the blade housing 110 may also be formed of a light transmitting material.

Below, a razor cartridge according to another embodiment of the present disclosure will be described. For convenience of explanation, parts similar to one embodiment are given the same drawing reference numerals, and parts common to one embodiment are omitted from description.

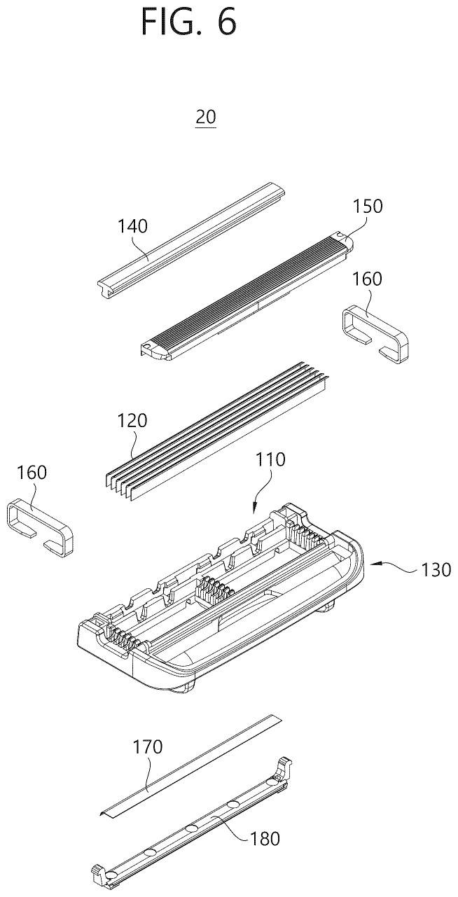

FIG. 6 is an exploded perspective view of a razor cartridge according to another embodiment of the present disclosure.

Referring to FIG. 6, a razor cartridge 20 according to another embodiment of the present disclosure has a difference in that the blade housing 110 and the housing cover 130 are formed integrally, compared to the razor cartridge 10 according to the above-described embodiment.

The blade housing 110 and the housing cover 130 may be formed integrally with a light-transmitting material.

Alternatively, the blade housing 110 may be formed of an opaque material, and at least a portion (for example, the front frame 133 or the plastic guard 133a) of the housing cover 130 may be formed of a light-transmitting material, but the blade housing 110 and the housing cover 130 may be formed integrally with a method such as double injection molding process.

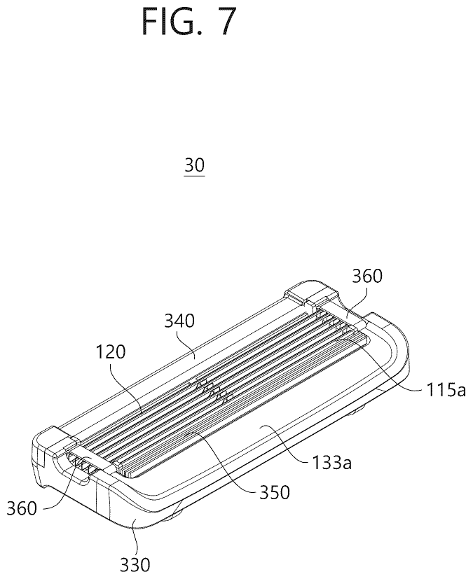

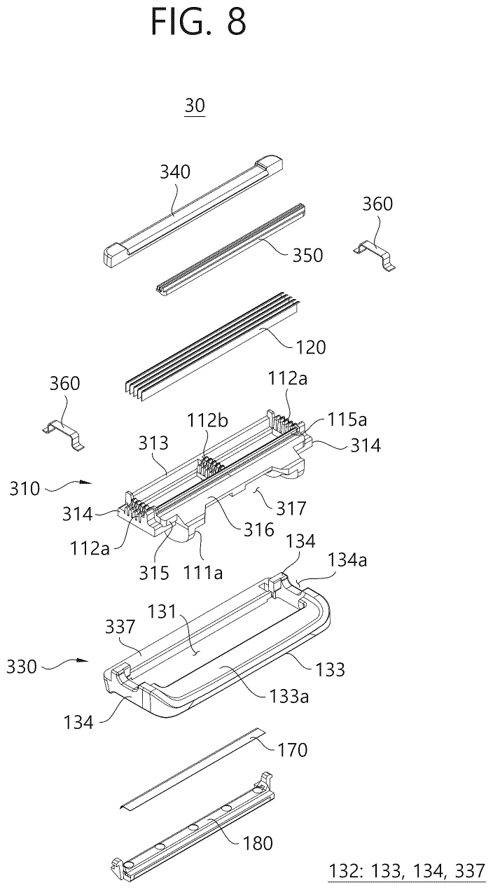

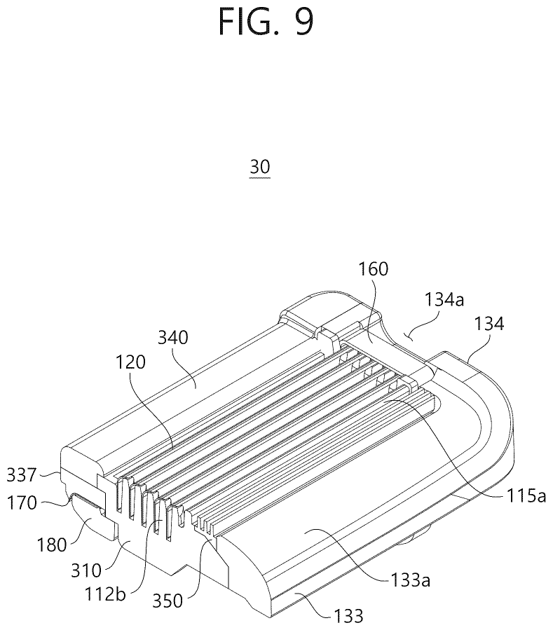

FIG. 7 is a perspective view illustrating a razor cartridge according to still another embodiment of the present disclosure, FIG. 8 is an exploded perspective view of the razor cartridge according to still another embodiment of the present disclosure, and FIG. 9 is a perspective view illustrating a cross section of the razor cartridge according to another embodiment of the present disclosure.

Referring to FIGS. 7 to 9, a razor cartridge 30 according to another embodiment of the present disclosure also includes a blade housing 310, a plurality of razor blades 120, and a housing cover 330, and may further include at least some of a lubricating band 340, an elastic guard 350, a clip 360, a trimming blade 170, and a trimmer support 180.

Referring to FIGS. 7 to 9, the razor cartridge 30 according to another embodiment includes a longitudinally extended lubricating band 340 compared to the razor cartridge 10 according to the above-described embodiment.

The lubricating band 340 according to the present embodiment may have a lubricating material applied to the entire upper surface including step portions on both left and right ends.

Referring to FIG. 8, the blade housing 310 includes a rear portion 313 positioned at the rear of the razor blade 120, side portions 314 positioned at each of the two sides of the razor blade 120, and a front portion 315 positioned at the front of the razor blade 120.

The side portions 314 on both sides may be provided with first razor blade support portions 112a that support and accommodate both sides of the razor blade 120. However, unlike the above-described embodiments, the side portion 314 may be formed so that the clip 360 is secured by covering the first razor blade support 112a without including the clip groove 114a.

Since there is no need to form the clip groove 114a, the side portion 314 does not need to include a portion protruding outwardly from the clip 360. Accordingly, a longitudinal width of the side portion 314 may be formed narrower, and the longitudinal length of the razor cartridge 30 can be designed smaller than the conventional cartridge compared to the longitudinal length of the razor blade 120. This makes the width where the actual hair is cut relatively longer compared to the overall width (longitudinal length) of the razor cartridge 30, and thus enables more intuitive shaving.

In a portion between the first razor blade support members 112a on both sides, a second razor blade support 112b may be provided to support and accommodate the central portion of the razor blade 120. Since the first razor blade support 112a and the second razor blade support 112b have been described in the above-described embodiment, further description thereof will be omitted.

The rear portion 313 may be formed to connect the side portions 314 on both sides, and the rear portion 313 may support at least a part of the lubricating band 340.

The front portion 315 may be formed to connect the side portions 314 on both sides, and a guard bar 115a disposed in front of the razor blade 120 may be formed on the upper surface of the front portion 315. Since the guard bar 115a has been described in the above-described embodiment, further description thereof will be omitted.

The lower surface of the front portion 315 is formed with the pair of connecting posts 111a as described above, and although not illustrated, the lower surface of the front portion 315 may be provided with the pair of guide surfaces (111b, see FIG. 2) and the connecting groove (111c, see FIG. 2).

The blade housing 310 may further include a guard support 316 extending forward from the guard bar 115a. The guard support 316 may support the elastic guard 350. The elastic guard 350 may perform a function similar to the elastic guard 150 of the above-described embodiment.

Referring to FIG. 8, a through slit 317 penetrating in the up and down direction may be formed in the guard support 316. The through slit 317 may be formed to be positioned within the connecting groove (111c, see FIG. 2).

Similar to the above-described embodiment, the elastic guard 350 may be configured such that a portion thereof is exposed to the lower surface of the blade housing 310 through the through slit 317. Since the effect of this configuration has been described in the above-described embodiment, further description thereof will be omitted.

In addition, the through slit 317 overlaps a portion of the plastic guard 133a, so that light transmitted through the plastic guard 133a from the rear of the razor cartridge 30 may be emitted to the front of the razor cartridge 10 through the through slit 317.

The housing cover 330 includes a razor blade window 131 through which at least a portion of the cutting edge of the razor blade 120 is exposed, and a window frame 132 formed to surround at least a portion of the razor blade window 131.

Referring to FIGS. 8 and 9, the window frame 132 may include a front frame 133 positioned in front of the razor blade 120, side frames 134 positioned on both sides of the razor blade 120, and a rear frame 337 positioned in the rear of the razor blade 120.

The front frame 133 may include a plastic guard 133a and may include an uneven region, similar to the above-described embodiment. Since the front frame 133 has been described in the above-described embodiment, further description thereof will be omitted.

The side frame 134 connects both sides of the front frame 133 and the rear frame 337, covers the clip 360, and is coupled to the side portion 314. Referring to FIGS. 8 and 9, a discharge hole 134a is formed in the side frame 134. The discharge hole 134a enables the lateral discharge of shaving residue and the lateral inflow of washing water, thereby improving the discharge and washing effects of shaving residue existing between the razor blades 120.

Compared to the above-described embodiments, the housing cover 330 according to the present embodiment may further include the rear frame 337.

Referring to FIGS. 7 to 9, a lubricating band 340 is mounted on the upper surface of the rear frame 337. The rear frame 337 and/or the side frame 134 may include a structure for coupling with the lubricating band 340.

Referring to FIG. 9, a trimmer accommodating groove (not illustrated) for accommodating a trimming blade 170 and a trimmer support 180 may be formed on a lower surface of the rear frame 337. Since the trimming blade 170 and the trimmer support 180 have been described in the above-described embodiments, further description thereof will be omitted.

According to the present embodiment, the housing cover 330 may be formed of a light transmitting material only for the plastic guard 133a, or may be formed of a light transmitting material only for the front frame 133. Alternatively, the housing cover 330 may be formed entirely of a light transmitting material.

The blade housing 310 according to the present embodiment may be formed of an opaque material to be distinguished from the housing cover 330, but according to the embodiment, the blade housing 310 may also be formed of a light transmitting material.

In addition, as illustrated in FIG. 8, the blade housing 310 and the housing cover 330 may be formed separately and configured to be mutually coupled, but similar to the razor cartridge 20 according to another embodiment, the blade housing 310 and the housing cover 330 may be formed integrally.

In this case, the blade housing 310 and the housing cover 330 may be formed integrally of a light-transmitting material. Alternatively, the blade housing 310 is formed of an opaque material, and at least a portion (for example, the front frame 133 or the plastic guard 133a) of the housing cover 330 is formed of a light-transmitting material, and the blade housing 310 and the housing cover 330 may be formed integrally through a method such as double injection molding process.

FIG. 10 is a side view schematically illustrating a razor assembly according to one embodiment of the present disclosure.

Referring to FIG. 10, the razor assembly 1 according to one embodiment of the present disclosure includes the razor cartridge 10 and a razor handle 40 to which the razor cartridge 10 is rotatably coupled.

The razor handle 40 includes a handle body 41, a handle head 42, and a light source 43.

The handle body 41 is a portion that is gripped by the user.

The handle head 42 is provided at one end of the handle body 41 and is detachably coupled to the connector 111 of the razor cartridge 10, and can rotatably support the coupled razor cartridge 10. Although not illustrated, a connecting member coupled to the connecting groove 111c may be provided at the end portion of the handle head 42.

The handle body 41 and/or the handle head 42 may be provided with the light source 43 that emits light toward the plastic guard 133a of the razor cartridge 10. A battery (not illustrated) that supplies power to the light source 43 may be provided inside the handle body 41, and a switch (not illustrated) that turns the light source 43 ON/OFF may be provided on the outer surface of the handle body 41.

Light L1 emitted from the light source 43 is incident on the plastic guard 133a from the lower surface of the razor cartridge 10.

Since the plastic guard 133a is formed of a light transmitting material, the light L1 incident on the plastic guard 133a passes through the plastic guard 133a and is emitted to the upper surface of the razor cartridge 10.

Since light L2 emitted through the uneven region of the plastic guard 133a passes through the uneven region and is arbitrarily refracted, even light L1 emitted from the point light source 43 can be emitted to the skin as light L2 with an overall uniform intensity.

According to one embodiment of the present disclosure, the razor assembly 1 can emit light L2 onto the skin just before hair is cut, so that the user can accurately recognize the area where shaving is to be performed, and shave is possible even in a dark environment.

Although the razor assembly 1 coupled with the razor cartridge 10 according to one embodiment is illustrated and described, the same or similar effects may be achieved in the razor assembly 1 in which the razor cartridges 20 and 30 according to another embodiment is applied instead of the razor cartridge 10 according to one embodiment.

A person having ordinary skill in the art to which the present disclosure belongs will be able to understand that the present disclosure may be implemented in other specific forms without changing the technical idea or essential features thereof. Therefore, the embodiments described above should be understood as illustrative and not limiting in all respects. The scope of the present disclosure is indicated by the claims described below rather than the detailed description above, and all changes or modifications derived from the meaning and scope of the claims and their equivalent concepts should be interpreted as being included in the scope of the present disclosure.

What is claimed is:

1. A razor cartridge comprising:
at least one razor blade having a cutting edge formed thereon;
a blade housing configured to accommodate the razor blade in a longitudinal direction; and
a housing cover including:
a razor blade window configured to expose at least a portion of the cutting edge, and
a window frame surrounding at least a portion of the razor blade window and connected to the blade housing,
wherein the window frame includes a plastic guard provided in front of the razor blade, and
wherein the plastic guard comprises a transparent or translucent material.

2. The razor cartridge of claim 1, wherein at least a portion of an upper surface of the plastic guard includes an irregularly patterned uneven region.

3. The razor cartridge of claim 2, wherein a longitudinal surface roughness (Ra) of the uneven region has a value between 100 micrometers and 300 micrometers.

4. The razor cartridge of claim 1, wherein a ratio of an area of the plastic guard to a cartridge front region located in front of the razor blade has a value between 0.2 and 0.9.

5. The razor cartridge of claim 1, wherein the upper surface of the plastic guard is located lower than the cutting edge.

6. The razor cartridge of claim 1, wherein the blade housing comprises an opaque material, and
wherein the blade housing and the housing cover are integrally formed.

7. The razor cartridge of claim 1, wherein the blade housing comprises an opaque material, and
wherein the housing cover is connectable to the blade housing.

8. The razor cartridge of claim 1, wherein the blade housing includes a guard bar located in front of the razor blade and side portions located in each of both sides of the razor blade.

9. The razor cartridge of claim 1, wherein the window frame includes a front frame arranged in front of the razor blade and a side frame arranged in each of both sides of the razor blade.

10. The razor cartridge of claim 1, further comprising a connector formed on a lower surface of the blade housing facing an upper surface of the blade housing where the cutting edge is exposed.

11. The razor cartridge of claim 10, wherein the connector is formed integrally with the blade housing.

12. The razor cartridge of claim 10, wherein the connector is arranged so as not to overlap the razor blade.

13. A razor assembly comprising:
a razor cartridge; and
a razor handle,
wherein the razor cartridge includes:
at least one razor blade having a cutting edge formed thereon,
a blade housing which accommodates the razor blade in a longitudinal direction and to which the razor handle is coupled, and
a housing cover including:
a razor blade window configured to expose at least a portion of the cutting edge, and
a window frame surrounding at least a portion of the razor blade window and connected to the blade housing,
wherein the window frame includes a plastic guard provided in front of the razor blade, and
wherein the plastic guard comprises a light-transmitting material.

14. The razor assembly of claim 13, wherein the razor handle includes a light source that emits light toward the razor cartridge, and
wherein at least a portion of the light emitted from the light source is configured to transmit through the plastic guard.

15. The razor assembly of claim 13, further comprising an elastic guard positioned between the razor blade and the plastic guard.

16. The razor assembly of claim 13, wherein an upper surface of the plastic guard is positioned lower than the cutting edge.

17. The razor assembly of claim 13, wherein the blade housing comprises an opaque material, and
wherein the blade housing and the housing cover are integrally formed.

18. The razor assembly of claim 13, wherein the blade housing comprises an opaque material, and
wherein the housing cover is connectable to the blade housing.

19. The razor assembly of claim 1, further comprising an elastic guard positioned between the razor blade and the plastic guard.
